(19) United States
(12) Patent Application Publication
(10) Pub. No.: US 2017/0038281 A1
(43) Pub. Date: Feb. 9, 2017

(54) METHOD OF PREDICTING LIFE OF COMPONENT OF MACHINE

(71) Applicant: Caterpillar Inc., Peoria, IL (US)

(72) Inventors: Ankitkumar P. Dhorajiya, Dunlap, IL (US); William D. Hankins, Edelstein, IL (US); Vishnu Gaurav Selvaraj, Trichy (IN); Kavitharani Ramamoorthy, Kovilpatti (IN); John Mathew, Ernakulam (IN); Balaraju Bende, Hyderabad (IN)

(73) Assignee: Caterpillar Inc., Peoria, IL (US)

(21) Appl. No.: 15/332,752

(22) Filed: Oct. 24, 2016

(51) Int. Cl. G01M 99/00

(52) U.S. Cl. CPC G01M 99/008

(57) ABSTRACT

A method of predicting life of a component of a machine is provided. The method includes receiving input data associated with the machine from a data repository. The input data include data associated with machine events and repairs. The method further includes analyzing the input data. Analyzing the input data includes determining a time difference between the machine event and the repair associated with the machine event, a repair reoccurrence, and the repair and a repair of an associated component. Analyzing the input data includes mapping the data associated with the machine event and repair based on the time difference, determining a weightage of a parameter for the machine events and the repairs based on the mapping, and computing a confidence rate of the machine event and the repair based on the weightage. The method further includes generating maintenance data of the component based on the confidence rate.

### TECHNICAL FIELD

The present disclosure relates to maintenance of a machine, and more particularly to a method of predicting life of a component of the machine.

### BACKGROUND

Machines disposed at a worksite undergo diagnosis, maintenance, and repair at frequent intervals due to wear and tear of multiple components thereof. Expert knowledge and/or diagnostic equipment may be required to ensure that the machines are properly diagnosed, maintained, or repaired. However, unanticipated defects to multiple components of the machine may occur, leading to unexpected delay for operations to be performed at the worksite. The technicians may thus need to have expertise in diagnosis and be able to correlate the occurrence of various related or seemingly-unrelated premature failures. Typically, the machines represent large capital investments and are capable of providing substantial productivity when in operation. It may therefore be important to predict component, sub-system, and/or system failures so that servicing can be scheduled during periods in which productivity will be less affected. Hence, any minor repairs can be made before they lead to potentially catastrophic failures of the machines.

U. S. Patent Publication Number 2016/0069778 describes a system for predicting failure of one or more components of a machine. The system includes at least one interface configured for inputting current repair data for a first component, a database configured to log the current repair data of the first component, and a processor operably connected to the at least one interface and the database. The processor analyzes the current repair data of the first component based on historic repair data stored in the database. The historic repair data includes the identity of a plurality of components of the machine, including the first component and a second component. The processor generates a recommendation for servicing the second component based on the historic repair data stored in the database.

### SUMMARY OF THE DISCLOSURE

In one aspect of the present disclosure, a method of predicting life of a component of a machine is disclosed. The method includes receiving input data associated with the machine from a data repository. The input data corresponds to a plurality of machine events with a time stamp corresponding to each of the plurality of machine events for a predefined time period. The input data also corresponds to a plurality of repairs of the component with a time stamp corresponding to each of the plurality of repairs for the predefined time period. The method further includes analyzing the input data. The analyzing of the input data includes determining a time difference between at least one machine event and at least one repair of the component associated with the machine event. The analyzing of the input data includes determining a time difference of a repair reoccurrence of the component. The analyzing of the input data includes determining a time difference of at least one repair and a repair of an associated component. The analyzing of the input data includes mapping the at least one machine event with the at least one repair of the component associated therewith based on the determined time difference. The analyzing of the input data further includes mapping the repair reoccurrence of the component based on the determined time difference. The analyzing of the input data also includes mapping the at least one repair to the repair of the associated component based on the determined time difference. The analyzing of the input data further includes determining a weightage of at least one parameter for the at least one machine event and the at least one repair based on the mapping. The parameter includes at least one of a recency of repair of the component, a frequency of repair of the component and a monetary value of the component The analyzing of the input data includes computing a confidence rate of occurrence of the at least one machine event and the at least one repair of the component based on the weightage determined. The method of predicting life of the component includes generating maintenance data of the component based on the confidence rate. The maintenance data includes at least one of a life of the component, a probability of repair of the component following the at least one machine event, and a probability of the repair of the associated component of the machine following the at least one repair of the component. The method of predicting life of the component includes displaying the maintenance data.

Other features and aspects of this disclosure will be apparent from the following description and the accompanying drawings.

### BRIEF DESCRIPTION OF THE DRAWINGS

FIG. 1 is a schematic block diagram showing a system for predicting life of a component of a machine disposed at a worksite;

FIG. 2 is a schematic block diagram of a controller of the system of FIG. 1;

FIG. 3 is an exemplary tableau dashboard for displaying maintenance data generated by the system of FIG. 1; and

FIG. 4 is a flowchart illustrating a method of predicting life of the component of the machine.

### DETAILED DESCRIPTION

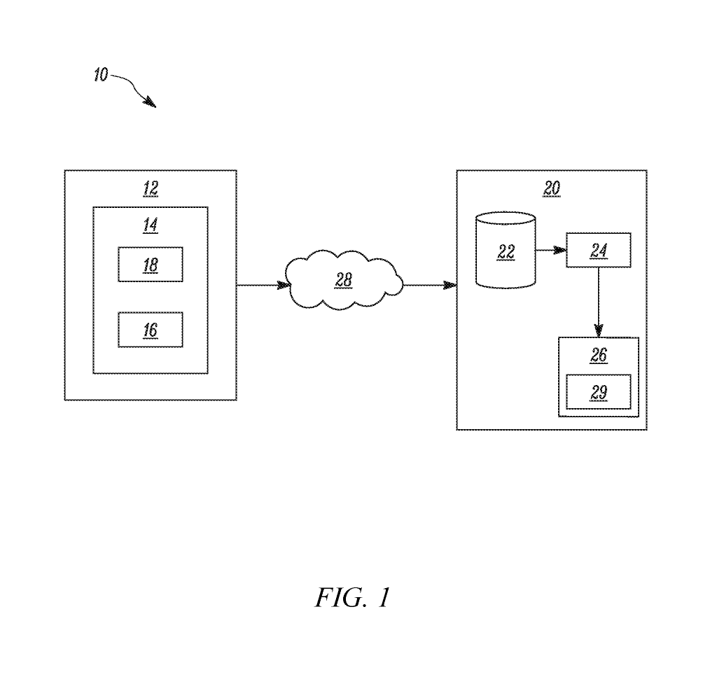

FIG. 1 illustrates an exemplary environment 10 having a worksite 12 and a machine 14 deployed at the worksite 12 for performing one or more operations including, but not limited to, earth moving operation, loading of material, and transportation of material from one location to another. In another example, the environment 10 may include more than one worksite and multiple machines operating at the worksite 12. The machine 14 includes various components, systems, sub-systems, such as an engine, a transmission system, a gear system, ground engaging members, an implement system, a power system, a cooler or heat exchanger, an intake and/or exhaust manifold, a brake group and various other components for performing various operations of the machine 14. For illustration purpose of the present disclosure, a component 16 of the machine 14 is explained in detail hereinbelow. In an example, the component 16 may be a single part component of the machine 14, an assembly, a system or a sub-system of the machine 14. The single-part component may be, for example, an oil seal, a fluid conducting tube, and a fluid control valve. The machine 14 may embody at least one of a vital information management system, a fleet management system, and a terrain management system for collecting and storing data associated with the machine 14. The machine 14 further includes sensors 18 communicably connected with the component 16 of the machine 14. The sensors 18 detect operating parameters of the component 16. The sensors 18 can be of any sensors known in the art for producing electrical signals in response to detected operating parameters. The sensors 18 further generate sensor data including, but not limited to, pulse-width modulated sensor data, frequency-based data, five volt analog sensor data, and switch data. The sensors 18 may also be connected to an electronic control module (ECM) (not shown) of the machine 14.

The ECM is configured to monitor a plurality of machine events based on the sensor data. The ECM is also configured to monitor a plurality of repairs associated with the machine 14. The ECM transmits the sensor data associated with at least one of the plurality of machine events and the plurality of repairs to a system 20 for predicting a life of the component 16 of the machine 14. In an example, the system 20 may be connected to multiple worksites and multiple fleets of machines for monitoring the machine events and the repairs of a particular component of the fleet of machines.

The system 20 is in communication with the ECM of the machine 14 via a network 28. Examples of the network 28 may include, but not limited to, a wide area network (WAN), a local area network (LAN), an ethernet, an internet, an intranet, a cellular network, a satellite network, or any other known network for transmitting and receiving data. In another example, the network 28 may include a combination of two or more of the aforementioned networks and/or other types of networks known in the art. Further, the network 28 may be implemented as a wired network, a wireless network, or a combination thereof. Data transmission takes place over the network 28 with a network protocol such that the data transmission is in an encrypted format or any other secure format. The system 20 includes a data repository 22, a controller 24, and a user interface 26.

The data repository 22 of the system 20 stores data associated with at least one of the plurality of machine events and the plurality of repairs of the machine 14. The data repository 22 may include any type of data storage device including, but not limited to, a data base, a data warehouse, a server, and a computer. In another example, the ECM of each of the multiple machines at different worksites may be networked together to form the data repository 22. In one example, the data repository 22 may be located proximal to the worksite 12. In another example, the data repository 22 may be located remotely at an apt location in the worksite 12. In some examples, the data repository 22 may include a repair and warranty database for storing repair data and warranty data associated with the machine 14 or the fleet of machines. The data repository 22 stores data collected using the vital information management system of the machine 14. A communication of data to and from the data repository 22 may be continuous or periodic. For instance, the data transmission may be accomplished using a wireless communication system, a wired connection, or by transferring a recording medium, such as flash memory and floppy disk, between the machine 14 and the data repository 22.

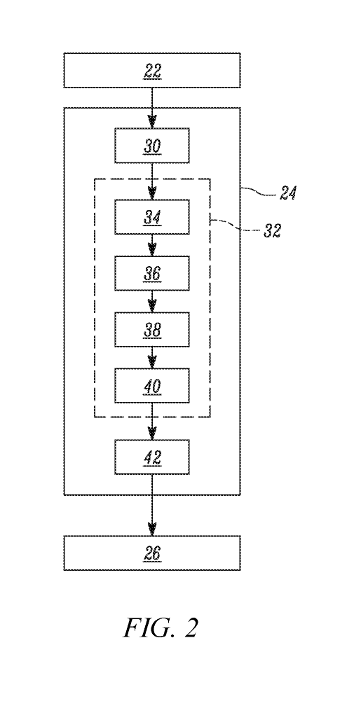

The data repository 22 is communicably coupled to the controller 24. In an example, the controller 24 may be a processor including a single processing unit or multiple processing units, each of which may include a plurality of computing units. The explicit use of the term ‘processor’ should not be construed to refer exclusively to hardware capable of executing a software application. Rather, in this example, the controller 24 may be implemented as one or more microprocessors, microcomputers, digital signal processor, central processing units, state machine, logic circuitries, and any device that is capable of manipulating signals based on operational instructions. Among the capabilities mentioned herein, the controller 24 may also be configured to receive, transmit, and execute computer-readable instructions. The controller 24 is configured to receive input data from the data repository 22 and generate maintenance data. The functionalities of the controller 24 and various modules of the controller 24 are explained in detail with reference to FIG. 2.

The controller 24 is communicably coupled to the user interface 26. The user interface 26 is a display device including, but not limited to, an LCD, CRT, and plasma display. The display device includes a graphical user interface (GUI). The display device is configured to display the maintenance data generated by the controller 24 to an operator, The graphical user interface includes a tableau dashboard 29 for displaying the maintenance data. In one example, the tableau dashboard 29 may statistically represent the maintenance data.

Referring to FIG. 2, a schematic block diagram of the controller 24 of the system 20 is illustrated. The controller 24 includes a data receiving module 30 for receiving input data from the data repository 22. The input data includes data associated with the plurality of machine events for a predefined time period. The predefined time period may include time period such as number of days, number of weeks, and number of years as defined by the operator. In one example, the predefined time period may be defined based on an availability of data space in the data repository 22. The plurality of machine events include, but not limited to, temperature rise of engine oil, wear of ground engaging members of the machine 14, and a performance reduction of a power storage unit of the machine 14. The input data also includes a time stamp corresponding to each of the plurality of machine events. For example, the controller 24 receives input data associated with the machine event, such as the rise in engine oil temperature and a corresponding time at which the rise in engine oil temperature is detected. The data associated with the plurality of machine events is referred to as “machine event data” hereinafter. The input data further includes data associated with the plurality of repairs of the component 16 identified by a part number of the component 16 and a time stamp corresponding to each of the plurality of repairs. The time stamp indicates when the component 16 was repaired. The data associated with the plurality of repairs is referred to as “repair data” hereinafter. In one example, the input data includes the machine event data and the repair data associated with the fleet of machines.

The input data includes historical data associated with the machine 14, such as repair history data collected and stored in the data repository 22 for the predefined time period. The input data may also include inspection data across the fleet of machines for the predefined time period. The data stored in the data repository 22 may also originate from, for example, a technician, machine manufacturer, dealers, and/or service providers. The repair data and/or the machine event data can also be collected and logged in the data repository 22 either manually.

The controller 24 further includes an analytical module 32. The analytical module 32 is configured to analyze the input data. In an example, the analytical module 32 may include a statistical model for determining a confidence rate of occurrence of at least one repair of the plurality of repairs of the component 16 following at least one machine event of the plurality of machine events. The at least one machine event is hereinafter referred to as “the machine event”. The at least one repair is hereinafter referred to as “the repair”. The analytical module 32 is configured to further include a statistical model for determining a confidence rate of a repair reoccurrence of the component 16. The repair reoccurrence may be referred to as an occurrence of a second repair of the component 16 following a first repair within a predefined time interval. For example, the predefined time interval is the number of days at which the repair reoccurred for the component 16. The predefined time interval may range from a number of days to a number of months. The analytical module 32 also includes a statistical model for determining a confidence rate of occurrence of at least one repair of an associated component (not shown) of the machine 14 following the repair of the component 16.

Referring to FIG. 2, at a block 34, the analytical module 32 is configured to determine a time difference between the machine event and the repair of the component 16 associated with the machine event. More specifically, a particular machine event may be followed by a corresponding repair within a time interval due to the machine event of the component 16. For example, the machine event such as drop in engine oil level may lead to a repair of engine oil seal of the machine 14. At the block 34, the analytical module 32 is further configured to determine a time difference of repair reoccurrence of the component 16. The time difference of the repair reoccurrence may be the time difference between a second repair of the component 16 following a first repair within a predefined time interval. At the block 34, the analytical module 32 is also configured to determine a time difference between the repair and the repair of the associated component. For example, a repair of a transmission system of the machine 14 may lead to a repair of a gear system connected to the transmission system of the machine 14. The input data may include details of the repair and the time stamp of the transmission system and details of the repair and the time stamp of the gear system. The time difference between the repair of the transmission system and the repair of the gear system is determined at the block 34.

At a block 36, the analytical module 32 is configured to map the machine events with the repair associated with the machine events of the component 16 based on the time difference determined at the block 34. More specifically, the machine event is mapped with the repair occurred within a predefined time limit after the machine event The predefined time limit may be defined based on a type of the component 16 and a specification of the component 16. If the determined time difference is within the predefined time limit, the machine event is mapped with the repair associated with the machine event. At the block 36, the analytical module 32 is further configured to map the first repair and the second repair occurred within the predefined time after the first repair. If the determined time difference between the first repair and the second repair of the component 16 is within the predefined time limit, then the repair reoccurrence is mapped. At the block 36, the analytical module 32 is also configured to map the repair of the component 16 to the repair of the associated component based on the time difference determined at the block 34. For example, the repair of the transmission system of the machine 14 is mapped with the repair of the gear system connected to the transmission system, if the repair of the transmission system is followed by the repair of the gear system within the predefined time limit. The mapping of the repair of the transmission system with the repair of the gear system is performed if the time difference determined at the block 34 is within the predefined time limit.

The analytical module 32 is configured to determine a weightage of a parameter for the repair and the machine event at a block 38. The weightage of the parameter is determined based on the mapping performed at the block 36. The parameter includes at least one of a recency of repair of the component 16, a frequency of repair of the component 16 and a monetary value involved in the repair of the component 16. The analytical module 32 includes a recency, frequency, and monetary (RFM) analysis algorithm. The RFM algorithm is applied on the mapped machine event data and the repair data. The weightage may also be referred to as RFM score of the parameter. Further, based on the input data, the analytical module 32 also provides an UM threshold. The UM threshold may be predetermined for the parameter of the repair by the analytical module 32. The weightage is compared with the RFM threshold, Based on the comparison, the machine event and the repair having the weightage of parameter greater than the RFM threshold are selected for determining the life of the component 16.

At a block 40, the analytical module 32 is configured to compute a confidence rate of the machine event having the weightage of parameter greater than the RFM threshold. At the block 40, the analytical module 32 is also configured to compute a confidence rate of the repair of the component 16 having the weightage of parameter greater than the RFM threshold. Accordingly, the analytical module 32 correlates the machine event data with the repair data to identify a pattern of the repair occurrences of the component 16. Subsequently, the confidence rate of the machine event occurred within the predefined time period and the repair of the component 16 followed by the machine event is computed.

In order to compute the confidence rate occurrence of the machine event and the repair of the component 16, an algorithm accessible by or stored in the analytical module 32 is to be utilized. More specifically, the algorithm applied in the block 40 may be a version of an Apriori algorithm, which is generally understood as a generic type of algorithm useful for data mining and determining the frequency at which information in a dataset appear. Data mining may refer generally to the process of discerning patterns in data sets and extracting useful information. The Apriori algorithm is applied to the mapped machine event data and the repair data and determines the likelihood of this sequence happening again.

The analytical module 32 also determines the confidence rate of the repair reoccurrence of the component 16 using the mapped first repair with the second repair at the block 40. The analytical module 32 further determines the confidence rate of occurrence of the repair of the associated component following the repair of the component 16 based on the mapped repair with the repair of the associated component. In one example, the confidence rate may correspond to a confidence percentage (%). The confidence percentage may indicate the likelihood of occurrence of the machine event followed by the repair associated with the machine event. The confidence percentage may also indicate the likelihood of the repair reoccurrence of the component 16. The confidence percentage may also indicate the likelihood of repair the associated component following the repair of the component 16.

The controller 24 includes a maintenance data generation module 42. The maintenance data generation module 42 receives the confidence rate from the analytical module 32 and generates maintenance data of the component 16 based on the confidence rate. The maintenance data includes the life of the component 16. The life of the component 16 may be understood as a survival of the component 16 for the predefined time period. In one example, the maintenance data is generated based on the machine data and the repair data of the fleet of machines. The life of the component 16 may be predicated based on the confidence rate of the repair of the component 16. The maintenance data also includes a probability of the repair of the component 16 following the machine event. The probability of the repair of the component 16 following the machine event is generated based on the determined confidence rate of the occurrence of the second repair associated followed by the machine event. The maintenance data further includes a probability of the repair of the associated component of the machine 14 upon repair of the component 16. In order to determine the probability of the repair of the associated component of the machine 14 upon the repair of the component 16, the repair of the associated component is correlated with the repair of the component 16. The maintenance data generation module 42 communicates the maintenance data to the user interface 26. In an example, the user interface 26 is the display device. The generated maintenance data is displayed in the display device. In one example, the maintenance data is displayed as the tableau dashboard 29 on the display device.

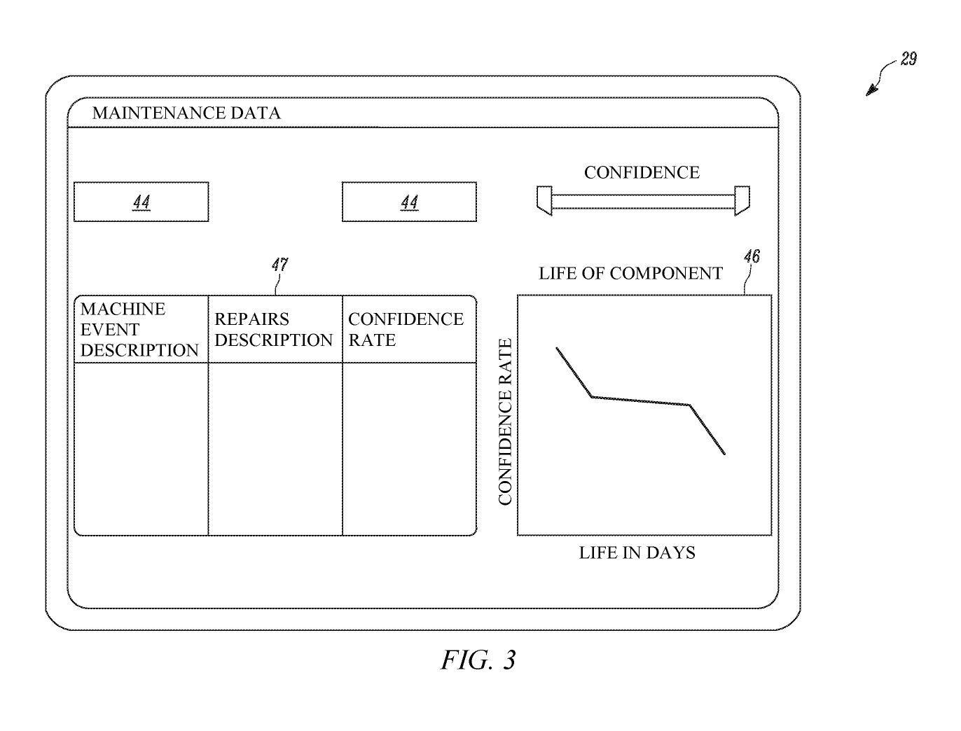

FIG. 3 illustrates an exemplary tableau dashboard 29 for displaying the maintenance data generated by the controller 24. The tableau dashboard 29 has primary identifications 44 including, but not limited to, type of machine, a part number of the component 16. The tableau dashboard 29 further includes event description and repair description including, but not limited to, component specification, monetary value of the component 16. The tableau dashboard 29 includes the maintenance data and the corresponding confidence rate. In one example, the tableau dashboard 29 includes a graphical representation 46 of the maintenance data. The tableau dashboard 29 includes a table 47 representing the maintenance data. In an exemplary tableau dashboard 29, the life of the component 16 may be represented in terms of days, month and the like.

### INDUSTRIAL APPLICABILITY

The system 20 and a method 48 of the present disclosure enable predicting the life of the component 16 of the machine 14. The system 20 assists in generating notifications indicating an estimated probability of the repair and, which can help the dealers and/or the service providers to take measure to attend the repair. Moreover, the system 20 predicts possible failure of the component 16 associated with the machine event. The system 20 also predicts possible failure of the associated component of the machine 14 having the repair. The method 48 of predicting life of the component 16 offers proactive repair planning and parts inventory management.

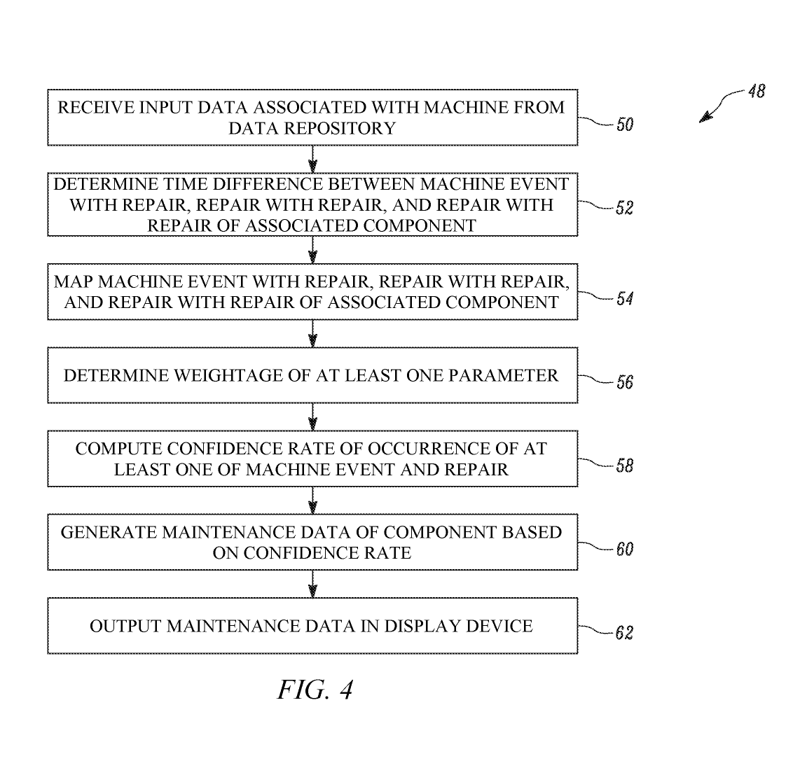

FIG. 4 a flowchart illustrating the method 48 of predicting the life of the component 16 of the machine 14. At a step 50, the controller 24 receives the input data associated with the machine 14 from the data repository 22. The input data includes data associated with the plurality of machine events with the time stamp corresponding to each of the plurality of machine events for the predefined time period. The input also includes the plurality of repairs of the component 16 with a time stamp corresponding to each of the plurality of repairs for the predefined time period. The input data may be historical data associated with the machine 14 or the fleet of machines disposed at the one or more worksites.

The controller 24 analyzes the input data for predicting the life of the component 16. In order to analyze the input data, at a step 52, the controller 24 determines the time difference between each of the plurality of machine events and the associated repair of the component 16. At the step 52, the method 48 includes determining the time difference of the repair reoccurrence of the component 16. At the step 52, the method 48 also includes determining the time difference between each of the plurality of the repairs and the repair of the associated component.

At a step 54, the controller 24 maps the machine event with the repair associated with the machine event based on the determined time difference between the machine event and the repair of the component 16. At the step 54, the method 48 further includes mapping the repair reoccurrence of the component 16 based on the determined time difference of the repair reoccurrence of the component 16. At the step 54, the method 48 also includes mapping the repair with the repair of the associated component based on the determined time difference the repair and the repair of the associated component.

At a step 56, the method 48 includes determining the weightage of the at least one parameter for the machine event. At the step 56, the controller 24 also determines the weightage of the at least one parameter for the repair. The weightage is determined based on the mapping performed at the step 54. The parameter includes at least one of the recency of repair of the component 16, the frequency of repair of the component 16 and the monetary value of the component 16. Further, at the step 58, the method 48 includes computing the confidence rate of the machine event and the repair of the component 16 based on the weightage determined for the parameter.

At the step 60, the method 48 includes generating the maintenance data of the component 16 based on the confidence rate. The maintenance data includes at least one of the life of the component 16, the probability of repair of the component 16 following the machine event, and the probability of the repair of the associated component following the repair of the component 16. At the step 62, the method 48 includes displaying the maintenance data as the tableau dashboard 29 on the display device.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed, Such embodiments should be understood to fall within the scope of the present disclosure as determined based upon the claims and any equivalents thereof.

What is claimed is:

1. A method of predicting life of a component of a machine, the method comprising:
receiving input data associated with the machine from a. data repository, wherein the input data correspond to a plurality of machine events with a time stamp corresponding to each of the plurality of machine events and a plurality of repairs of the component with a time stamp corresponding to each of the plurality of repairs for a predefined time period;
analyzing the input data including:
determining a time difference between at least one machine event and at least one repair of the component associated with the at least one machine event, a repair reoccurrence of the component, and at least one repair of the component and a repair of an associated component;
mapping the at least one machine event with the at least one repair of the component associated therewith, the repair reoccurrence of the component, and the at least one repair to the repair of the associated component based on the determined time difference;
determining a weightage of at least one parameter for the at least one machine event and the at least one repair based on the mapping, wherein the parameter includes at least one of a recency of repair of the component, a frequency of repair of the component and a monetary value of the component; and
computing a confidence rate of occurrence of the at least one machine event and the at least one repair of the component based on the weightage determined;
generating maintenance data of the component based on the confidence rate, wherein the maintenance data includes at least one of a life of the component, a probability of repair of the component following the at least one machine event, and a probability of the repair of the associated component of the machine following the at least one repair of the component; and
displaying the maintenance data.
